(19) United States
(12) Patent Application Publication
(10) Pub. No.: US 2025/0096653 A1
(43) Pub. Date: Mar. 20, 2025

(54) A MOTOR ASSEMBLY

(71) Applicant: SIMPLEX MOTION AB, GÖTEBORG (SE)

(72) Inventor: Johan LINDER, VÄSTRA FRÖLUNDA (SE)

(73) Assignee: SIMPLEX MOTION AB, GÖTEBORG (SE)

(21) Appl. No.: 18/727,228

(22) PCT Filed: Dec. 15, 2022
(86) PCT No.: PCT/SE2022/051185

§ 371 Date: Jul. 8, 2024

(30) Foreign Application Priority Data
Jan. 24, 2022 (SE) 2250062-3

(51) Int. Cl. H02K 11/215; H02K 21/22

(52) U.S. Cl. CPC H02K 11/215; H02K 21/22; H02K 2211/03

(57) ABSTRACT

The present disclosure generally relates to a motor assembly. comprising an electrical motor and a control unit connected to and adapted to control an operation of the electrical motor. In line with the present disclosure. at least one multi-axis magnetic sensor is used for measuring a magnetic flux originating from the magnetic poles of an external rotor comprised with the electrical motor, where the measured magnetic flux is used for controlling a current provided to the electrical motor.

### TECHNICAL FIELD

The present disclosure generally relates to a motor assembly, comprising an electrical motor and a control unit connected to and adapted to control an operation of the electrical motor. In line with the present disclosure, at least one multi-axis magnetic sensor is used for measuring a magnetic flux originating from the magnetic poles of an external rotor comprised with the electrical motor, where the measured magnetic flux is used for controlling a current provided to the electrical motor.

### BACKGROUND

In many applications where electric motors are used, a smooth rotation of the rotor of the electric motor, and therefore also a precise control of the rotor current and the wave shape thereof, are required. To be able to achieve a sufficiently precise control, it is required that the angular position of the rotor can be detected in an accurate manner. Usually, in conventional electric motors, an angle sensor or resolver, together with associated electronics, are used for determining the angular position. The angle sensors detect mechanical movement and convert the detected movement into electric signals. Optical pulse sensors and absolute angle sensors are two commonly occurring types of angle sensors. Both of these solutions are generally bulky and generally provides a low resolution in the angular position determination.

An alternative solution for angular position determination is presented in U.S. Pat. No. 10,312,839B2. U.S. Pat. No. 10,312,839B2 discloses a motor assembly, comprising an electrical motor with control electronics which comprises two magnetic field sensors adapted to measure magnetic flux from magnetic poles on a rotor in the electrical motor. The magnetic field sensors are adapted to determine an angular position of the rotor, with the purpose of controlling the current to the electrical motor based on the determined angular position. The electrical motor is an electrical motor 102 comprising an internal stator, and an external rotor having a periphery and an inside, which exhibits a plurality of permanent magnets disposed at regular intervals along the inside to provide the magnetic poles. The magnetic field sensors are disposed at a distance from each other in the proximity of the periphery to measure the magnetic flux leaking radially through the external rotor from the permanent magnets on the inside. Specifically, the two magnetic field sensors are placed with a distance of ¼ the distance between two motor pole pairs. This is to achieve a 90-degree phase shift on the two sensor signals. These signals can then be converted to a rotor angle by use of inverse trigonometry.

As compared to the use of angle sensors, the solution in U.S. Pat. No. 10,312,839B2 greatly improves the reliability and resolution of the angular position determination as well as providing for a more compact implementation for achieving the angular position determination. However, there are some drawbacks with the solution as is presented in U.S. Pat. No. 10,312,839B2. For example, the distance between the sensors on the circuit board is affected by the motor size and the number of poles in the motor, causing redesign of the circuit board for each new motor design. Additionally, since the sensors are placed on a flat circuit board, and the rotor is cylindrical, it is not easy to calculate the correct distance. Typically, there will be an error contribution from the phase difference not being exactly 90 degrees. In addition to the above, the distance between the rotor and the circuit board will affect the sensor distance, and tolerances on circuit board placement in production will also contribute to the motor position error.

Thus, it would generally be desirable to introduce some form of flexibility to angular position determination using magnetic field sensors, possibly allowing for such a solution to be useful in relation to different type of electrical motors.

### SUMMARY

According to an aspect of the present disclosure, the above is at least partly alleviated by a motor assembly, comprising an electrical motor and a control unit connected to and adapted to control an operation of the electrical motor, wherein the electrical motor comprises an internal stator and an external rotor, the external rotor is provided with a preset number of pole portions arranged at an inside of the external rotor and adapted to form magnetic poles, the motor assembly further comprises at least one single chip multi-axis magnetic sensor connected to the control unit and arranged in a proximity of a periphery of the external rotor to measure a magnetic flux originating from the magnetic poles of the external rotor, and the control unit is further adapted to determine an angular position of the rotor based on the measured magnetic flux, and control a rotation of the electrical motor based on the determined angular position.

The present disclosure is based upon the understanding that the use of a multi-axis magnetic sensor, provided in a single chip solution, would allow for a one-point measurement of the magnetic flux generated outside of the electrical motor during operation of the electrical motor. By means of such a one-point measurement, it will be possible to position the one multi-axis magnetic sensor where the magnetic flux from the electrical motor is determined to have a desired level/amplitude, not necessarily placing the same type of strict radial positioning constraints on the multi-axis magnetic sensor as compared to what was needed when using the prior-art solution with a pair of one-axis magnetic field sensors.

In comparison, when using two separate sensor components, as in prior art, most of the position error comes from phase misalignment between the two sensors. When using a one-point measurement, there is no separation between sensor elements and hence no phase misalignment. There may however still be error components from other effects, such as signal distortion. Most of the error is cyclic along the electrical turn and can easily be compensated by a lookup table across the electrical turn, since the angle that results from the trigonometric calculations is an absolute angle within the electrical turn.

As an alternative, it may according to the present disclosure be possible to arrange the control unit to implement a CORDIC calculation scheme for estimating the angular position of the rotor. Such a scheme may reduce the computational burden placed onto the control unit.

Using a multi-axis magnetic sensor in the form of a single chip solution may advantageously allow for a cost-effective solution with less parts and lower cost. Using two sensors in the same component also improves performance as the sensors are matched. Since the two sensors reside on the same silicon die and have been manufactured simultaneously, they are not affected by process variations and have very similar performance. This is an important advantage over using two separate sensors that exhibit a larger variation in bias and noise figures.

Accordingly, the combined measurement values produced by the single chip multi-axis magnetic sensor will allow for improvements in the determination of the angular position of the rotor, as compared to what is achievable using two separate components. Additionally, since a one-point measurement is provided it may be possible to increase the flexibility of how to mount the multi-axis magnetic sensor relative to the motor.

In a possible embodiment of the present disclosure the control unit is further adapted to receive the preset number of pole portions, and the angular position of the rotor is further based on the received preset number of pole portions. Accordingly, as compared to prior-art implementations, it will by means of the implementation according to the present disclosure be possible to make use of the same hardware implementation for different types of motors, independent on the number of poles, without having to redesign e.g. a printed circuit board (PCB) holding the control unit and the at least one single chip multi-axis magnetic sensor. Thus, the present disclosure further reduces the overall cost of the motor assembly, since the hardware can be maintained independent on the motor type. Instead, only the control unit need to be “informed” about the number of pole positions to be able to determine the angular position of the rotor.

Some errors are still present and may for example be dependent on differences between the electrical turns across the mechanical turn, such as for example based on distances between the rotor magnets across the entire rotor. These errors can be compensated by the introduction of a further sensor system that has been adapted to estimate the current electrical turn at each time, or by assuming that the amplitude of the magnetic field has a variation between the electrical turns and constitutes a fingerprint of the rotor. This is typically the case since the magnetic field strength of the individual magnets has a variation. By tracking the peak-to-peak amplitude of each passing electrical turn when the motor rotates, it is possible to determine the current electrical turn after a few rotations. This fingerprint of field strength variation can be stored in memory to identify the separate electrical turns and hence create an absolute motor position sensor across the entire mechanical turn. This absolute position across the mechanical turn can then be used to compensate for errors detected during calibration across the mechanical turn.

Preferably, the electrical motor is a permanent magnet synchronous machine. However, other types of electrical motors are possible and within the scope of the present disclosure, such as a brushless DC motor.

In a preferred embodiment, the preset number of pole portions comprises a plurality of permanent magnets arranged at regular intervals along the inside of the external rotor. Alternative, the preset number of pole portions may be arranged to comprise a plurality of magnetized ferrite magnets. In a still further alternative embodiment, the preset number of pole portions comprises at least one multi-pole ferrite magnet ring magnetized ferrite magnets.

In a possible implementation of the electrical motor, the electrical motor has more than six magnetic poles at the external rotor. However, it may, as discussed above, be possible to include less or more poles with the motor.

In some embodiments it may be desirable to equip the at least one multi-axis magnetic sensor with an analog to digital converter (ADC) as an internal element of the multi-axis magnetic sensor, and the at least one multi-axis magnetic sensor provides digitized data indicative of the measured magnetic flux to the control unit. Accordingly, the calculations may accordingly be performed with an improved reliability as compared to general prior-art solutions.

In such an embodiment it may be desirable to configure the at least one multi-axis magnetic sensor to provide data indicative of the measured magnetic flux to the control unit using a data bus communication protocol. Such a data bus communication protocol may for example be the I2C bus protocol, allowing swift integration with the control unit. The use of a “digital link” between the at least one multi-axis magnetic sensor and the control unit may allow for a reduction of noise since the analog to digital conversion is performed already at the at least one multi-axis magnetic sensor. The digital link between the at least one multi-axis magnetic sensor and the control unit may also be used for other components used in relation to the motor assembly, i.e. connected to the same I2C bus as the at least one multi-axis magnetic sensor.

However, in some embodiments it may be desirable to equip the control unit with an (internal) ADC and instead allow the analog to digital conversion to be performed internally at the control unit. An analog link is thus provided between each multi-axis magnetic sensor and the control unit. Additionally, it is suitable to handle analog data from each axis separately, thus providing an analog link for each axis. As such, in case the multi-axis magnetic sensor is arranged to provide analog measurements in relation to a first and a second axis, then a first and a second analog link is to be provided between the multi-axis magnetic sensor and the control unit.

An advantage using analog communication between the multi-axis magnetic sensor and the control unit is the ability to increase the amount of measurement data that is provided from the multi-axis magnetic sensor to the control unit. That is, in some embodiments, such as when the motor is expected to spin with an in comparison high RPM and/or the number of pole portions are in comparison high, then e.g. the digital link may have a bandwidth that is less than what is desirable for providing the control unit with enough information to perform reliable calculations.

Potentially, an ADC not included with the multi-axis magnetic sensor and at the same time arranged externally from the control unit may as an alternative be used instead of using a control unit with an internally arranged ADC.

As indicated above, the motor assembly preferably comprises a printed circuit board (PCB) adapted to receive the at least one multi-axis magnetic sensor and the control unit. The PCB is preferably planar and is arranged in at least one of a tangential orientation or a perpendicular orientation relative to an axis of the motor. A known orientation of the PCB relative the motor axis may further be used in the determination of the angular position of the rotor.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawing, in which:

FIG. 1 illustrates a cross-sectional view of a motor assembly according to an embodiment of the present disclosure, illustrating the structure and principle of operation of the motor assembly,

FIG. 2 presents a field line simulation for the multi-axis magnetic sensor when arranged in relation to a rotor,

FIG. 3 shows a flat motor with accompanying circuit board according to another embodiment of the present disclosure, and

FIG. 4 presents an exploded view of the motor illustrated in FIG. 3.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

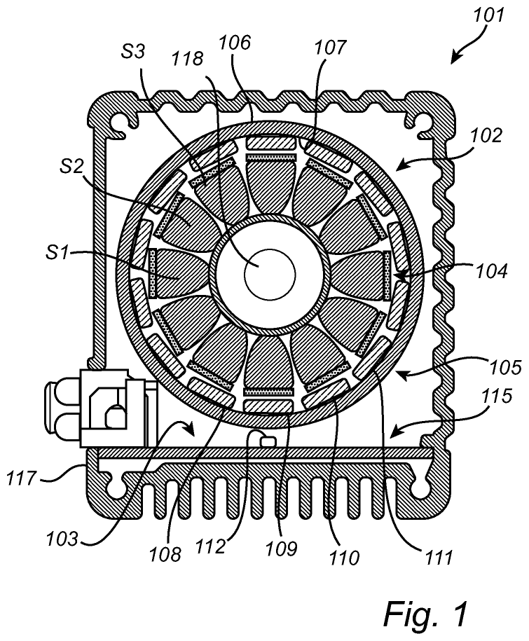

Referring now to the drawings and to FIG. 1 in particular, there is illustrated a schematic representation of a cross-section of a motor assembly 101 according to one embodiment of the present disclosure. The motor assembly 101 comprises an electrical motor 102 with control electronics 103. An electrical motor can also be defined as an alternating current motor with permanent magnets on the rotor and electronic commutation.

The control electronics 103 of the motor assembly comprises a single multi-axis magnetic sensor 112 adapted to measure magnetic flux from magnetic poles on a rotor in the electrical motor 102. The magnetic field sensors are adapted to determine an angular position of the rotor, based on the measurement of magnetic flux, with the purpose of controlling a rotation of the electrical motor based on the determined angular position. Such rotational control may for example be achieved by adjusting a current and/or voltage provided to the electrical motor.

The electrical motor 102 in the motor assembly according to the present disclosure comprises an external rotor 105. Electrical motors 102 of this type have become common as motors in model aircraft in the last few years and are commercially available. The electrical motor 102 further comprises an internal stator 104. The diagonally hatched areas S1, S2, S3 in FIG. 1 schematically illustrate the copper winding of the stator. The external rotor 105 has a periphery 106 and an inside 107, exhibiting a plurality of permanent magnets 108, 109, 110, 111.

In a preferred embodiment of the motor assembly 101 according to the present disclosure, the previously mentioned single chip multi-axis magnetic sensor 112 is a multi-axis Hall sensor, preferably a linear type Hall sensor. Single-axis Hall sensors are well known, per se, for use in control systems for electrical motors, and will therefore not be described more closely here. However, embodiments of the present disclosure where the magnetic field sensors are of another type are also conceivable, such as magnetoresistive sensors, magnetostrictive sensors or flux gate sensors. In the motor assembly according to the present disclosure, it is advantageous that the single chip multi-axis magnetic sensor 112 has small dimensions and few or no moving parts, which is the reason why Hall effect sensors or magnetoresistive sensors are preferred.

In the motor assembly 101 according to the present disclosure, the permanent magnets 108, 109, 110, 111 are disposed at regular intervals along the inside 107 of the external rotor to provide the previously mentioned magnetic poles, wherein the previously mentioned multi-axis magnetic sensor 112 is disposed at a distance from a periphery 106 of the external rotor 105 to measure the magnetic flux originating from the permanent magnets 108, 109, 110, 111 on the inside 107 of the external rotor 105.

Thanks to the combination of a measurement arrangement with a single chip multi-axis magnetic sensor 112 and permanent magnets belonging to the rotor of the electrical motor 102, which is used in the motor assembly according to the present disclosure, the previously mentioned angular position can be determined by measuring magnetic flux e.g. leaking through the external rotor 105, i.e. external relative to the stator, thus enabling the whole measurement arrangement to be simplified and the control electronics to be designed in a more compact fashion. Furthermore, particularly with Hall sensors, the measurement arrangement will provide a good measurement accuracy of about ±0.25° and a good resolution of about 0.025°.

An even number of permanent magnets 108, 109, 110, 111 are disposed on the inside 107 of the external rotor 105 of the electrical motor 102. Every other permanent magnet has the north pole facing inward, and every other has the south pole facing inward. Consequently, the smallest possible number of magnetic poles in the electrical motor 102 is two poles, which constitute an electrical cycle. An increased number of magnetic poles in an electrical motor 102 will therefore result in more electrical cycles in this electrical motor 102. Geometrically speaking, as expressed in degrees, the electrical cycle is equal to 2 times 360° divided by the number of magnetic poles.

The multi-axis magnetic sensor 112 is preferably adapted to produce both sine and cosine signals based on the measurement of the magnetic flux, wherein the control electronics 103 comprises at least one control unit (not shown) adapted to read and convert the measurement signals and calculate the rotor angle of the external rotor 105 in the electrical cycle of the electrical motor 102 based on the measurement signals. The control unit is particularly advantageously adapted to calculate the rotor angle by using inverse trigonometry and a calibrating curve.

The calculated angle from the measured magnetic sensors is used for two different purposes in brushless motor control applications. The first purpose is to find the correct commutation for the motor currents, the phase angle for the 3 phase currents to provide maximum torque output of the motor for a given current. For this it is desirable to update the measurement values at typically a 10-20 kHz rate. The angle value within the electrical turn is required for commutation, which is also the result from the direct trigonometric calculations from the magnetic sensor values.

The second purpose is to provide the motor position and/or speed to a controller that regulates the motor motion according to a set motion profile by commanding an appropriate motor torque value. This regulation is typically performed by a PID regulator that is fed with a requested position or speed value and the current position or speed value. If position control is the main purpose, the input is position values. In this case, it is desirable to convert the calculated rotor angle into a continuous motor position value that increments continuously across multiple electrical and mechanical turns. The same motor position value should also decrement in the opposite rotational direction of the motor. Typically, the update rate frequency of the PID regulator is lower than the commutation frequency by a factor of 5-10, which allows filtering of the position and/or speed values to increase signal to noise ratio.

Typically the system samples the magnetic sensors at a specified rate, the sampling frequency. At this frequency new rotor angle values are calculated. It is convenient to match this sampling frequency to the PWM switching frequency of the motor for commutation purposes. This frequency is typically in the 10-20 kHz range but can be both lower and higher.

One way of doing the conversion from rotor angle into motor position is to calculate the change in angle for each sampling period, taking wrap around effects into consideration. This angle difference value can be filtered to increase signal to noise ratio if needed. Then the motor position can be updated by simply adding the differential angle value to the motor position from the last update period. Scaling can be done to change the resolution from the rotor angle values to the motor position value, and also to compensate for number of electrical turns on one mechanical turn. Typically, the rotor angle values are handled by 16-bit integers across one electrical turn, while motor position values are represented as noise free values in 12-16 bit resolution per mechanical turn.

The control unit may be provided as an explicit computing device for example including a general-purpose processor, an application specific processor, a circuit containing processing components, a group of distributed processing components, a group of distributed computers configured for processing, etc. The processor may be or include any number of hardware components for conducting data or signal processing or for executing computer code stored in memory.

The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection.

The control unit is preferably adapted to implement the inverse trigonometry calculation by table look-up and interpolation. The control unit is particularly advantageously adapted to improve the accuracy of the estimation even further by applying a calibrating curve to the estimated angular position.

The function of the control electronics 103 may be divided into three main parts: 1) magnetic field sensors with associated signal processing; 2) signal conversion from sensor signals to angle, and further to which current to be supplied to which poles in the stator; and 3) power electronics supplying the current to the poles (possibly using a driver circuitry external of the control unit). Furthermore, the control electronics 103 provides a feedback function, so that a restoring torque will always be applied to the rotor in case of a deviation from a set point for the angular position of the rotor.

In a particularly advantageous embodiment of the motor assembly according to the present disclosure, the control electronics 103 comprises at least one planar circuit board 115 oriented tangentially to the periphery 106 of the external rotor 105, wherein the multi-axis magnetic sensor 112 and the control unit is mounted on this circuit board 115. Such an arrangement provides a simplified installation, and a motor assembly having a very small length in the axial direction. It should however be stressed that the use of the multi-axis magnetic sensor 112 allows for a flexible mounting of the magnetic sensor in relation to the external rotor 105. That is, the multi-axis magnetic sensor 112 must not necessarily be oriented tangentially to the periphery 106 of the external rotor 105.

In one advantageous embodiment of the motor assembly according to the present disclosure, the control electronics 103 is arranged to control position, speed or acceleration of the external rotor 105.

The electrical motor 102 of the motor assembly 101 according to the present disclosure is preferably provided with an output shaft 118, wherein a housing 117 is provided with a hole adapted for passage of the output shaft 118.

Advantageously, the outside of the motor assembly can exhibit at least one visible signaling device (not shown) for displaying a signal related to the angular position of the external rotor 105. In the motor assembly according to the present disclosure, differently colored lamps may be provided, where the lamps are adapted to indicate the instantaneous angular position of the rotor in a suitable manner, which may be an advantage when tuning the control electronics.

To enable the motor assembly 101 according to the present disclosure to be used as a servo motor or the like, the control unit is preferably adapted to be capable of communicating with a main control system providing set points for angular position, speed or acceleration.

Accordingly, in one advantageous embodiment, the motor assembly 101 exhibits at least one communication port (not shown) for connection to an external unit. Such a port for data communication can be designed with any suitable standard interface and be used for data communication between the motor assembly according to the present disclosure and an external control, measurement or diagnostic system.

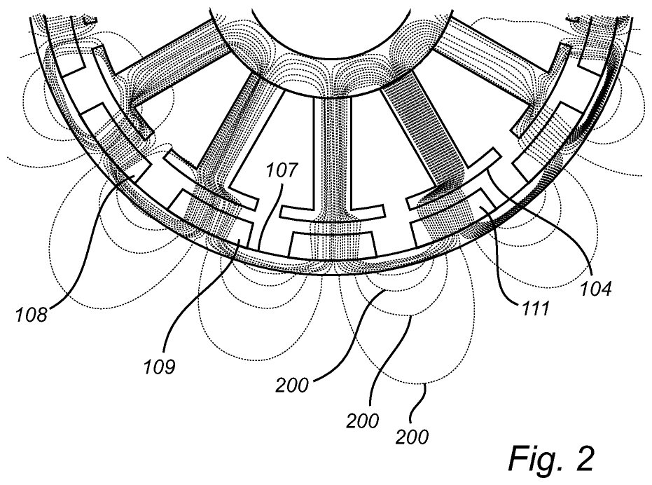

Turning now to FIG. 2, presenting a field line simulation for the multi-axis magnetic sensor 112 when arranged in relation to a rotor. As can be seen from FIG. 2, the magnetic field lines 200 in (any) one stationary point adjacent to the rotor will rotate in direction when the rotor turns. The field line directional vector will complete one 360-degree rotation for each motor pole pair that passes by.

This holds true both for measuring the magnetic field on the outer periphery of the rotor, and also measuring from a location at the end of the rotor in the axial extension. This allows several different circuit board orientations when designing an integrated motor system that incorporates both the motor, the control electronics, and the motor position sensor.

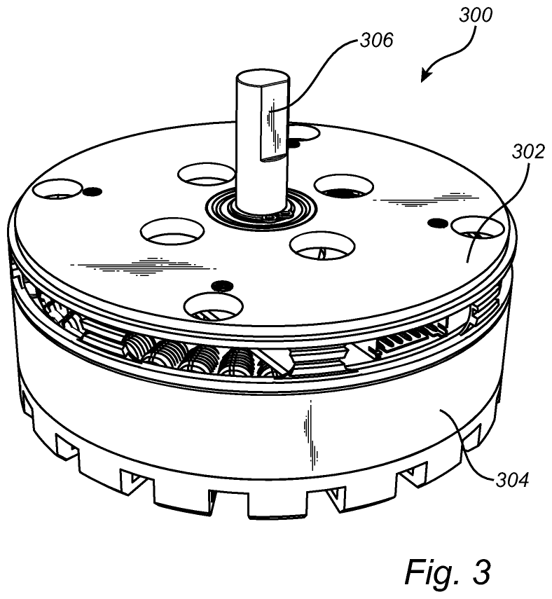

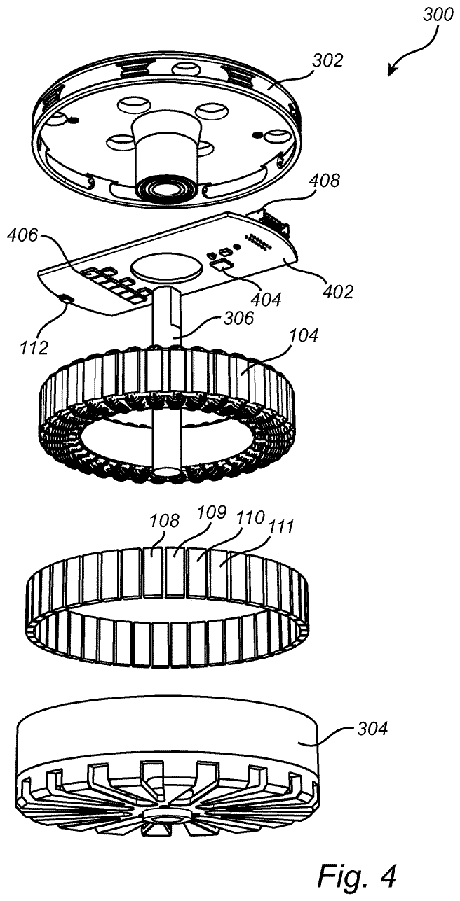

For example, when designing motors with high torque and low speed it is beneficial to have a large diameter and small length of the motor. In this case it may be advantageous to have a circuit board including both control electronics and the sensor oriented perpendicular to the motor shaft, as is exemplified by another embodiment of the motor assembly 300 of the present disclosure as exemplified in FIGS. 3 and 4.

The sensor would then measure at the end of the rotor in axial extension and measure magnetic field strength in the axial and tangential directions of the rotor with accompanying an circuit board 402.

Preferably and as shown in FIGS. 3 and 4, the flat motor assembly 300 has a circular external shape.

As is illustrated in FIGS. 3 and 4, the complete motor assembly 300 and all control components may be arranged within an enclosure 302 and 304 of the motor 300.

The motor 300 further comprises an axis 306, the circuit board 402, the plurality of permanent magnets 108-111 and the internal stator 104.

As can be seen in FIG. 4, the circuit board 402 has been adapted to follow an inner contour of the enclosure 302, thus fitting snuggly within the motor 300. The circuit board 402 comprises the single multi-axis magnetic sensor 112 as discussed above, a control unit 404, a driver stage 406 and a connector 408 that provides an electrical interface for the motor.

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the disclosure has been described with reference to specific exemplifying embodiments thereof, many different alterations, modifications and the like will become apparent for those skilled in the art.

Variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. A motor assembly, comprising:
an electrical motor, and
a control unit connected to and adapted to control an operation of the electrical motor,
wherein:
the electrical motor comprises an internal stator and an external rotor,
the external rotor is provided with a preset number of pole portions arranged at an inside of the external rotor and adapted to form magnetic poles,
the motor assembly further comprises at least one single chip multi-axis magnetic sensor connected to the control unit and arranged in a proximity of a periphery of the external rotor to measure a magnetic flux originating from the magnetic poles of the external rotor, and
the control unit is further adapted to:
determine an angular position of the rotor based on the measured magnetic flux, and
control a rotation of the electrical motor based on the determined angular position.

2. The motor assembly according to claim 1, wherein the control unit is further adapted to receive the preset number of pole portions, and the angular position of the rotor is further based on the received preset number of pole portions.

3. The motor assembly according to claim 1, wherein the electrical motor is a permanent magnet synchronous machine.

4. The motor assembly according to claim 1, wherein the electrical motor is a brushless DC motor.

5. The motor assembly according to claim 1, wherein the preset number of pole portions comprises a plurality of permanent magnets arranged at regular intervals along the inside of the external rotor.

6. The motor assembly according to claim 1, wherein the preset number of pole portions comprises a plurality of magnetized ferrite magnets.

7. The motor assembly according to claim 1, wherein the preset number of pole portions comprises at least one multi-pole ferrite magnet ring magnetized ferrite magnets.

8. The motor assembly according to claim 1, wherein:
the at least one multi-axis magnetic sensor is adapted to produce measurement signals from said measurement of the magnetic flux, and
the control unit is adapted to process the measurement signals to estimate the angular position of the external rotor within an electrical cycle of the electrical motor.

9. The motor assembly according to claim 8, wherein the control unit is adapted to estimate the angular position by using inverse trigonometry.

10. The motor assembly according to claim 9, wherein the inverse trigonometry is implemented by table look-up and interpolation.

11. The motor assembly according to claim 8, wherein the control unit is adapted to estimate the angular position by using a CORDIC calculation scheme.

12. The motor assembly according to claim 1, wherein the at least one multi-axis magnetic sensor comprises an analog to digital converter (ADC), and the at least one multi-axis magnetic sensor provides digitized data indicative of the measured magnetic flux to the control unit.

13. The motor assembly according to claim 1, wherein the at least one multi-axis magnetic sensor is configured to provide data indicative of the measured magnetic flux to the control unit using a data bus communication protocol.

14. The motor assembly according to claim 1, further comprising a planar printed circuit board (PCB) adapted to receive the at least one multi-axis magnetic sensor and the control unit, wherein the planar PCB is arranged in at least one of a tangential orientation or a perpendicular orientation relative to an axis of the motor.
